(19) United States
(12) Patent Application Publication
(10) Pub. No.: US 2009/0271831 A1
(43) Pub. Date: Oct. 29, 2009

(54) Mobile Instructional Videos

(76) Inventors: Joe Louis Binno, San Diego, CA (US); Steven C. Taylor, San Diego, CA (US)

Correspondence Address: FOLEY & LARDNER LLP, P.O. BOX 80278, SAN DIEGO, CA, 92138-0278, US

(21) Appl. No.: 12/239,682

(22) Filed: Sep. 26, 2008

Related U.S. Application Data
(60) Provisional application No. 60/995,358, filed on Sep. 26, 2007.

(51) Int. Cl. H04N 7/173

(52) U.S. Cl. 725/93

(57) ABSTRACT

The personal mobile trainer of the present invention provides a system and method for delivering a training video to an electronic device, including a cellular phone, personal digital assistant, micro PC, laptop computer, or desktop computer. The system and method facilitates convenient access to a broad range of training videos covering a multitude of applications and technologies.

### PRIORITY CLAIM

This application claims benefit of priority of provisional application Ser. No. 60/995,358 titled “MOBILE INSTRUCTIONAL VIDEOS” filed on Sep. 26, 2007, whose inventors are Joe Louis Binno, Steven C. Taylor, and Dion Mitchell, and claims the benefit of priority therefrom, so that the descriptions of which are all incorporated herein by reference.

### BACKGROUND OF THE INVENTION

U.S. Pat. No. 7,206,647 discloses a portable electronic device for use in an online environment, such as for online shopping, where it would be inconvenient or even impossible to use a desktop or laptop computer. For example, the patent discloses that a laptop computer used to access Internet shopping Websites may be susceptible to insecure transmissions when used in a public environment such as an airport. The portable electronic device is used for making Internet purchases, where the device purportedly incorporates shopping, security, authentication, and payment for use in the Internet shopping experience. The device types described for use in the invention are cell phones, personal digital assistants (PDAs), and portable laptop computers.

Similarly, U.S. Pat. No. 7,195,157 describes a consumer interactive shopping and marketing system, wherein the system allegedly employs an order selection and fulfillment system. A user may access the system from a home computer system, a dedicated order kiosk, or some other portable terminal, whereby the portable terminal includes telephony and video capabilities. For example, the system provides for a graphical display of a store layout for the user's ease in selecting virtual items similar to a shopping trip at an actual store. Specific user data may also be stored and then automatically retrieved in facilitating the user shopping experience, such as by providing a list of previous items the user has selected in previous shopping trips.

In U.S. Pat. No. 7,203,648, there is provided a method for sending multimedia messages with customized audio, such as sending a text message to a desired recipient where the text message is converted into an audio message that is presented via an electronic animated entity. The sender chooses from a series of predetermined animated entities with which to associate the audio and text messages. The method may also be referred to as combining voice with a “talking head or a computer-generated face that literally speaks to a person.” Special text-to-speech (TTS) software is required for the sender and user to take advantage of the particular system and method, which allegedly enables more creative and desirable control of animated multimedia messages.

Further, U.S. Patent Application No. 2007/0077921 describes a system and method for pushing podcasts to mobile devices from a remote subscription management system. As described in the application, podcasting distinctly requires a subscription model where a “feed” is used to monitor for and/or deliver a file, typically an electronic audio file such as music. Specialized software for subscribing to the broadcast “feeds” enables the user to receive automatic updates via podcatching software (also known as aggregator software). The disclosure specifies a need for a centrally-based subscription management service so that automatic updates and content, for example, can be pushed to the receiving device as determined by the subscription service. The user's ability to have centralized control over the receiving device(s) via the subscription management system is integral to the '921 application.

As cellular phones have become increasingly more sophisticated with multiple associated functionalities, the popularity of audio and video delivery by server-based feeds and similar means has grown apace. Various electronic file formats also facilitate the use of more sophisticated content that may be provided to portable devices based on user-defined preferences. However, each of the above-described patents/patent applications lacks the attendant features and advantages of the present invention as herein described.

### SUMMARY OF THE INVENTION

According to an aspect of the invention, there is provided a delivery method for providing a training video for a personal mobile trainer comprising: initiating an electronic query via a computerized electronic device or “e-device” such as a cell phone, personal digital assistant, notebook computer, or the like, to a centralized provider; receiving an opt-in message on the e-device from the centralized provider in response to the query; indicating an acceptance of the opt-in message from the centralized provider; receiving a selected video transmission of one or more videos from the centralized provider in response to the acceptance of the opt-in message from the centralized provider; and playing or storing the selected and received video within the e-device.

In accordance with another aspect of the invention, there is provided a delivery method as herein described wherein the electronic query is selected from a user-specified text message, a pre-formatted query list, an e-mail, and a voice input.

In accordance with yet another aspect of the invention, there is provided a delivery method as herein described wherein the e-device is selected from a cellular phone, a PDA, a micro PC, a laptop computer, a desktop computer, a networked laptop or desktop computer, a video player, an MP3 player, and a television.

In accordance with still another aspect of the invention, there is provided a delivery method as herein described wherein the centralized provider is selected from an affiliated server, a dedicated server, an associated server, and an open-access server.

In accordance with still another aspect of the invention, there is provided a delivery method as herein described wherein the opt-in message further comprises a disclaimer or a broadcast message.

In accordance with still another aspect of the invention, there is provided a delivery method as herein described wherein an affirmative response to the opt-in message comprises an electronic indication via text message or response by checking a yes box or its graphic equivalent.

In accordance with another aspect of the invention, there is provided a delivery method as herein described wherein the one or more selected video transmissions is streamed from the centralized provider to the e-device in response to a single acceptance of a block of videos requested, and wherein the one or more selected videos optionally contains audio therewith.

In still another aspect of the invention, there is provided a delivery method as herein described wherein the one or more videos is selected from a streaming video file, a burst video file, and a single electronic file.

In yet another aspect of the invention, there is provided a delivery method as herein described wherein the video is selected from: a cooking instructional video; a fitness training video; an exercise demonstration video; a furniture assembly instructional video; an automobile repair instructional video; an emergency medical first aid video; an automobile emergency instructional video; a personal health and nutrition instructional video; a self-defense training video; a foreign language or sign language training video; a dancing instruction video; a video resume; and a survival skills video.

In another aspect of the invention, there is provided a personal mobile trainer system comprising: an e-device means for initiating a query; a centralized provider (affiliated server; dedicated server; open-access server) means for providing (transmitting; distributing) user-selected video(s) (or means for emitting advertisement videos); an opt-in message electronically transmitted from the centralized provider; a user-indicative acceptance of the opt-in message (wherein the acceptance is indicated electronically via text message or response by checking a yes box or its equivalent); wherein the user-selected video comprises an instructional video; and wherein the e-device further comprises a means for playing and/or electronically storing the user-selected video distributed from the centralized provider.

In still another aspect of the invention, there is provided a personal mobile trainer system as herein described wherein the electronic query is selected from a user-specified text message, a pre-formatted query list, an e-mail, and a voice input.

In yet another aspect of the invention, there is provided a personal mobile trainer system as herein described wherein the e-device is selected from a cellular phone, a PIDA, a micro PC, a laptop computer, a desktop computer, a networked laptop or desktop computer, a video player, an MP3 player, and a television.

In another aspect of the invention, there is provided a personal mobile trainer system as herein described wherein the centralized provider is selected from an affiliated server, a dedicated server, an associated server, and an open-access server.

In still another aspect of the invention, there is provided a personal mobile trainer system as herein described wherein the opt-in message further comprises a disclaimer or a broadcast message.

In yet another aspect of the invention, there is provided a personal mobile trainer system as herein described wherein an affirmative response to the opt-in message comprises an electronic indication via text message or response by checking a yes box or its graphic equivalent.

In another aspect of the invention, there is provided a personal mobile trainer system as herein described wherein the one or more selected video transmissions is streamed from the centralized provider to the e-device in response to a single acceptance of a block of videos requested, and wherein the one or more selected videos optionally contains audio therewith.

In still another aspect of the invention, there is provided a personal mobile trainer system as herein described wherein the one or more videos is selected from a streaming video file, a burst video file, and a single electronic file.

In yet another aspect of the invention, there is provided a personal mobile trainer system as herein described wherein the video is selected from: a cooking instructional video; a fitness training video; an exercise demonstration video; a furniture assembly instructional video; an automobile repair instructional video; an emergency medical first aid video; an automobile emergency instructional video; a personal health and nutrition instructional video; a self-defense training video; a foreign language or sign language training video; a dancing instruction video; a video resume; and a survival skills video.

In another aspect of the invention, software code is written specifically to run on an e-device to allow optimal viewing on that particular multimedia player. For example, development of this software application for Microsoft's Windows Media Player can be facilitated by a software development kit or “SDK” provided for that particular multimedia player. A user can install such an e-device specific application by downloading from an Internet Website, or by other convenient installation means. Downloading from a Website has the advantage that the server can determine the type of media player that is installed on the e-device and provide the appropriate application. This application can additionally provide the user with the ability to choose preferences as to their particular categories of interest and then present appropriate choices of instructional video available for download in response to the user's preferences. The user can be provided the ability to enter further personal information, including physical characteristics such as height and weight, skin, eye, and hair color, etc. This personal information can then be used to further refine the selection of content to be provided to the user. In addition to multimedia instructional content, the user can be provided with recommendations as to the appropriate product to use and where it may be obtained. In a further embodiment, the server can create an account for the user where the multimedia content they have selected can be stored, thereby obviating the problem of losing or replacing their e-device. In a further aspect of the invention, a user can send a text message via, for example, short message service or “SMS” indicating a particular product, device, or category such as, for example, a hair gel, a medical device, or martial arts instruction, respectively. The server can then respond by providing for download an appropriate multimedia instructional video.

As an alternative to downloading a media player application and/or receiving multimedia content for a user's c-device and, there can be provided physical media containing a data file for installing the multimedia player application and/or multimedia content. This physical media can be in the form of an inexpensive and compatible data storage medium such as a flash memory device such as a USB flash or “thumb” drive, an Smart Digital or “SD” card, or any convenient media for storing a executable digital file that is readable by the e-device. These types of media can be included inside the packaging of various products; for example, a cosmetic product could include a media device having instructional video showing the proper use of the product. Similarly, a hardware product could include instructional video showing how to assemble the hardware product. The user can insert the media into the e-device and install the appropriate media player specific application and/or view various multimedia files stored therein.

Still other objects, features, and attendant advantages of the invention will become apparent to those skilled in the art from a reading of the following detailed description of embodiments constructed in accordance therewith, and taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 presents a flowchart demonstrating one example according to an embodiment of the invention; and

FIG. 2 provides an example of an embodiment of the invention where the selected video initial screen and associated screens show a training exercise being demonstrated.

FIG. 3 depicts an exemplary embodiment setting forth the steps required for carrying out the invention over a network such as the Internet.

FIG. 4 depicts an exemplary embodiment setting forth the steps required for carrying out the invention with application data and media content delivered by means of physical storage media.

FIG. 5 presents an exemplary embodiment of the structure of a network server according to one aspect of the invention.

FIG. 6 depicts various possible elements of a system according to certain exemplary embodiments of the invention.

### DETAILED DESCRIPTION OF PREFERRED EMBODIMENTS

Referring to the drawing figures, like reference numerals designate identical or corresponding elements throughout the several figures.

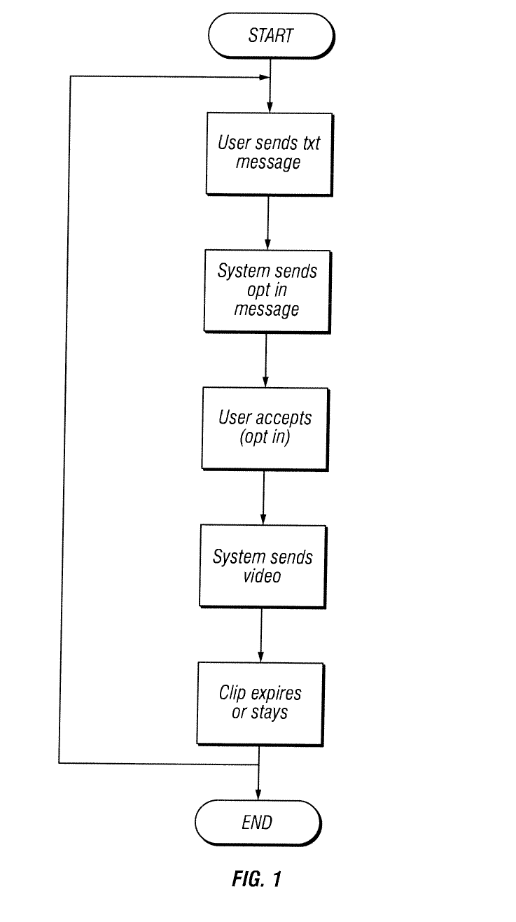

In FIG. 1 there is provided a flowchart showing an example of a procedure for practicing the invention. In this exemplary embodiment, the user initiates an electronic query (“user initiation”), such as by sending a text message from an c-device, to a specified centralized provider (also referred to as a server). The electronic query may be a single communication such as a text message to the server as described, or may also be a series of selected items (i.e., two or more items) from a preformatted electronic list that can be simultaneously sent by the user. The user may alternatively dial a specific phone number from his e-device, or electronically access a particular Internet (or Intranet) Website, and select the desired item or items from a pre-populated list. Further, the server, phone number, Website, etc., may contain one or more groups of lists that facilitate ease of use for the user in selecting the desired items. The lists, for example, may be a set of checkboxes where the user simply selects one or more items of interest by placing a check in the specific box or boxes. The server may be a dedicated server, an associated server, a group of one or more interfaced servers, or the like. Further, multiple servers may be used to organize similar content therein, thus maximizing efficiency in providing users with multiple servers from which to choose specific desired content, while also providing redundant capability where a single server interruption will not cause any interruption in service.

Next, after the server receives the electronic query, the server correspondingly responds to the user (“server response”) by sending an electronic response that is also referred to as an opt-in message. This opt-in message may be in the form of a simple “yes” or “no” check box, or may alternatively be a response text message serving as the user's acceptance to the opt-in message. Further, the opt-in message can include electronic response generated via an electronic mail (e-mail) message, through one or more specific Websites, or via any other Internet-based system. Upon sending an acceptance to the opt-in message or its equivalent, the server may be configured to provide the user with a payment screen, in order to provide videos for purchase or rent at a specified charge. The server may also be configured to provide such videos as blocks of videos for a set payment amount, or may also include individualized pricing for each video, depending on the configuration established for specific video content providers.

Once the server registers the user's electronic acceptance (“user acceptance or decline”), the server initiates transmission of the requested electronic file to the user (“video delivery”). For example, the server transmits an entire video file (with optional audio) as a burst transmission, so that the user may then play or store the file on the receiving e-device. Alternatively, the server transmits a streaming video file (again with optional audio), whereby the receiving e-device begins to play the video immediately upon receipt. In another embodiment, the server responds with an active hyperlink (also called a link) that electronically directs the user to the video for immediate streaming to the e-device. After the video delivery process and/or playback is complete, the user may repeat the entire video request and delivery process from the same or other e-device an infinite number of iterations for other videos, regardless of whether the videos cover the same general subject matter. Various electronic file formats may be employed, so that the e-device does not require specific costly software to play the file. Examples of supported electronic file formats include, but are not limited to, 3G, 3G2, 3GP, 3GCP, 3GPP, 3GPP2, AVI, MP4, and WMV formats. Other compressed or uncompressed electronic file formats are also within the scope of the invention, and the efficiency in transmitting compressed file formats is also advantageously contemplated herein. Where the server responds with a file that the user does not wish to view, the user declines by either affirmatively sending a “cancel” message to the server, or the user indicates no acceptance in the indicated preformatted message from the server. Moreover, the disclaimer as presented herein refers to a legal liability disclaimer of responsibility, as well as to an affirmative agreement relating to fee charges for the video or videos, as appropriate.

In an embodiment of the invention, the video component can be simultaneously played with accompanying audio on the e-device. Alternatively, the video and audio components may also be played separately and/or sequentially. For example, where a user receives an electronic file or hyperlink for playback and initiates playback, or where the file is streaming from the server to the e-device for immediate playback with no apparent delay, the user may choose to pause the video during playback. However, the user may allow the audio portion to continue, so that the user may view a static image while receiving further audio instructions. One specific example is when viewing a user manual or set of instructions for a particular activity such as cooking instructions, where the user could view the desired presentation of a cooking recipe via the paused video image while continuing to listen to the audio instructions for assembling the dish. The video/audio files of the present invention also allow the user to pause, rewind, and fast-forward the presentation on the e-device numerous times. In an embodiment, the audio portion of the file is heard along with the video clips, where an individual narrator explains the activity being presented in the image (e.g., an exercise demonstration video) so that the activity is properly performed. An example of a fitness training video presents video images of the body part or parts being exercised, while the narrator explaining the activity is not visible in the video image, and the image frequently shows a close-up image of the proper exercise and the relevant body part configuration to maximize the user's physical workout efficiency.

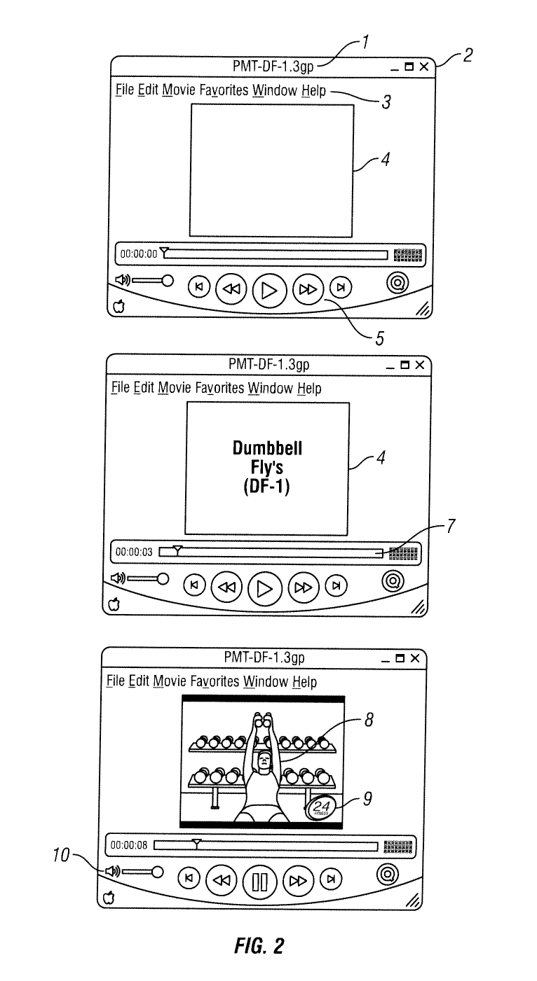

As shown in an embodiment presented in FIG. 2, the electronic file identifier 1 may be displayed on the e-device display screen at the top of the video, although the file identifier 1 may also be displayed at various other positions surrounding the video, or even on the playback screen 4 of the video itself. Further, the file identifier may alternatively be displayed prior to playback of the video, but not displayed anywhere on the playback screen 4 during viewing of the video file. The minimize, maximize and go-away action boxes at position 2 are displayed on the e-device during playback of the video file, although these action boxes 2 need not be present on all e-devices, depending on the user's established display preferences. The playback menu 3 provides options to the user, such as: opening, closing and/or selecting file types for playback; electronic editing capabilities such as copying and pasting (where this feature is not inactivated by copyright-protected files), and the like; selecting a specific movie from a list of files and/or file types; a selected list of favorites as determined by the user; the ability to move between multiple window screens; and an electronic help function. These functions are not limited to those described herein, and one of ordinary skill in the art readily understands other video functions may be included within these drop-down listing of functions within the file and e-device. The control function softkeys 5 provide the user with fast-forward, fast-reverse, forward skip, reverse skip, play, and pause functions. The exemplary embodiment of these softkeys 5 presented in FIG. 2 also includes the appearance of other softkeys having different visual aesthetics but identical function. The time bar 7 displays the elapsed time of the video being played, or may display the total time or time remaining, depending on user-set preferences for this time bar 7. The video file type may also affect the appearance of the various items as shown in FIG. 2.

An example of a training video as shown in FIG. 2 presents a visual subject 8, where the user views and follows the activity on the playback screen 4. Playback, pause, fast-forward, and the like are controlled by the control function softkeys 5 as described above. The logo 9 may be an advertising logo or other useful link, as described herein. The volume adjust 10 may be present on the e-device screen or may be separately controlled by other electronic control according to the specific e-device being used.

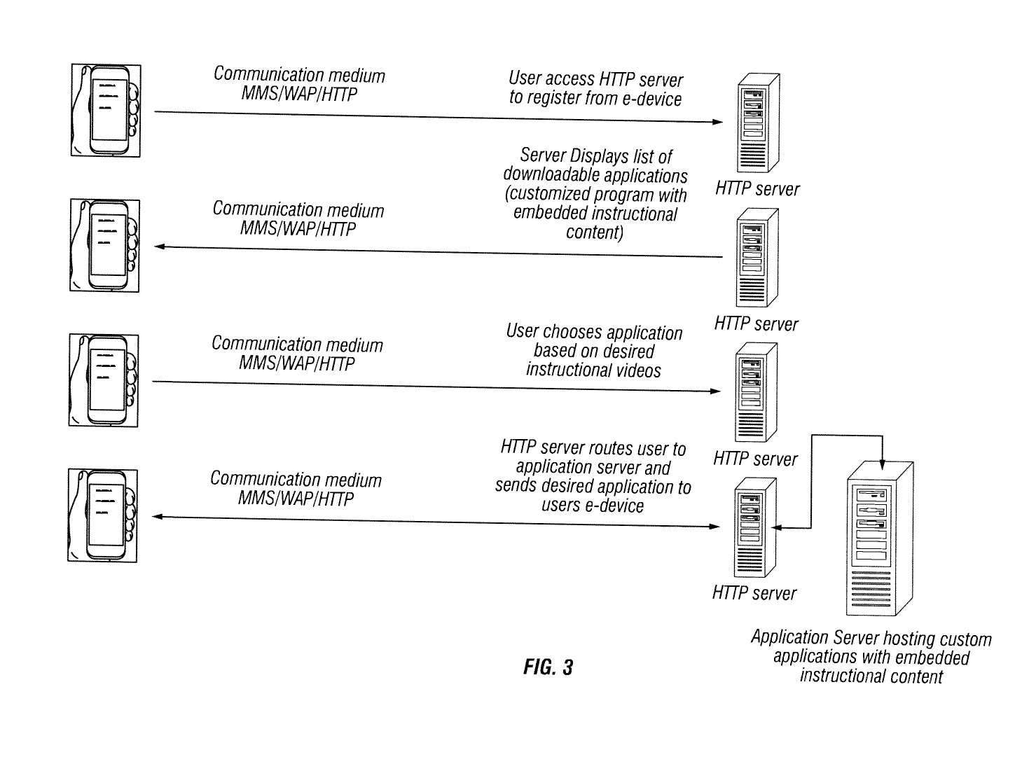

The term “e-device” refers to electronic devices to be used within the scope of the invention. Examples of e-devices include, but are not limited to, wireless devices such as cellular telephones, personal digital assistants (PDAs), laptop computers, desktop computers, smart telephones, smart displays, micro personal computers (micro PCs) and the like. FIG. 3 presents an example of the steps for carrying out one aspect of the invention. An e-device (11) initiates a communication query via a network such as the World Wide Web by any suitable means including sending a text message, activating a hot link on a Web page etc. to a recipient such as the HTTP server (12). HTTP server (12) responds by presenting to the e-device (1I) a graphical or text display of choices of downloadable applications having embedded instructional content. The c-device then may select one or more of the presented choices and transmit the choice or choices back to the HTTP server (12). HTTP server (12) then routes the e-device together with the selected choices to an application server (13), which then downloads the selected application(s) and/or instructional content to the e-device.

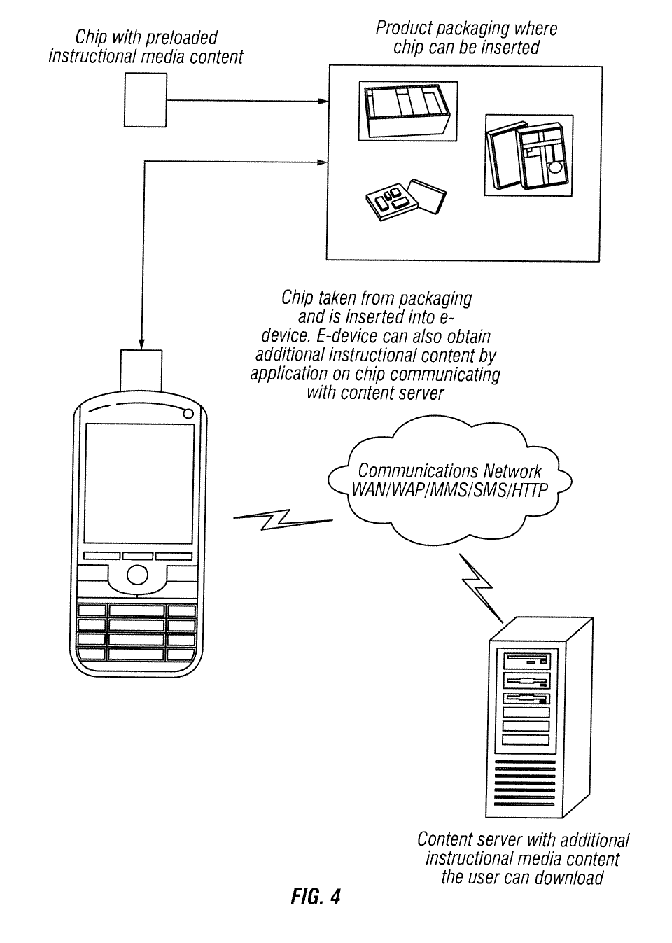

FIG. 4 presents an alternative embodiment of the invention whereby instructional content, video and/or audio, and an associated software application is made available in a physical data storage media format such as a Secure Digital, USB flash drive, or any other convenient media format that can be accessed by the e-device. The compact nature and low cost of modern physical data storage media makes it suitable for inclusion in a wide range of product packaging. By inserting or otherwise placing the data storage media in communication with the e-device, the user is then able to launch the application contained therein, thereby allowing the user to view the instructional content on the e-device. The application my further provide the e-device user with the ability to communicate with an application server (13) either directly or via an HTTP server (11) using the World Wide Web or similar network.

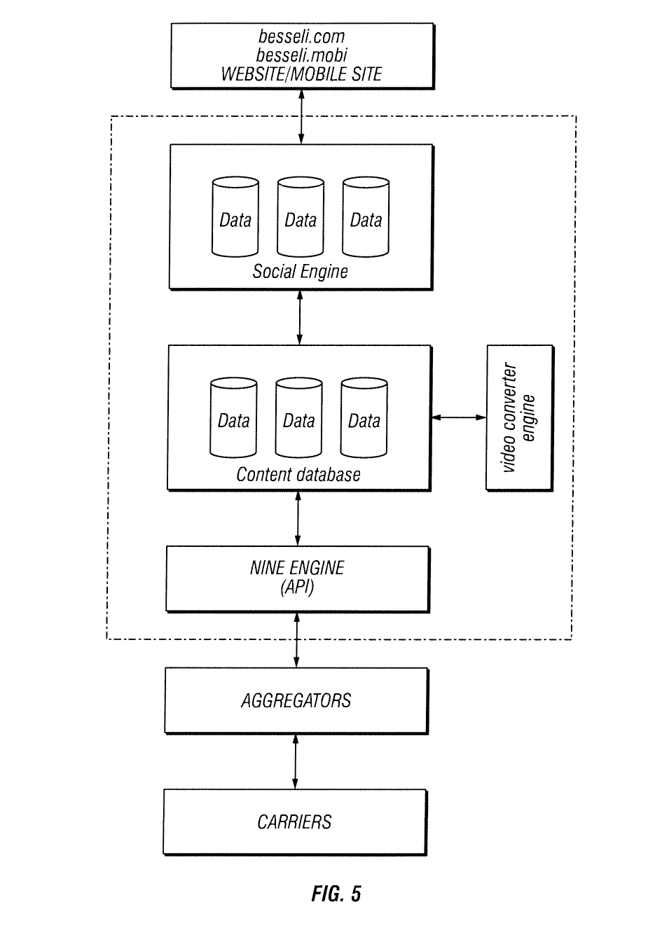

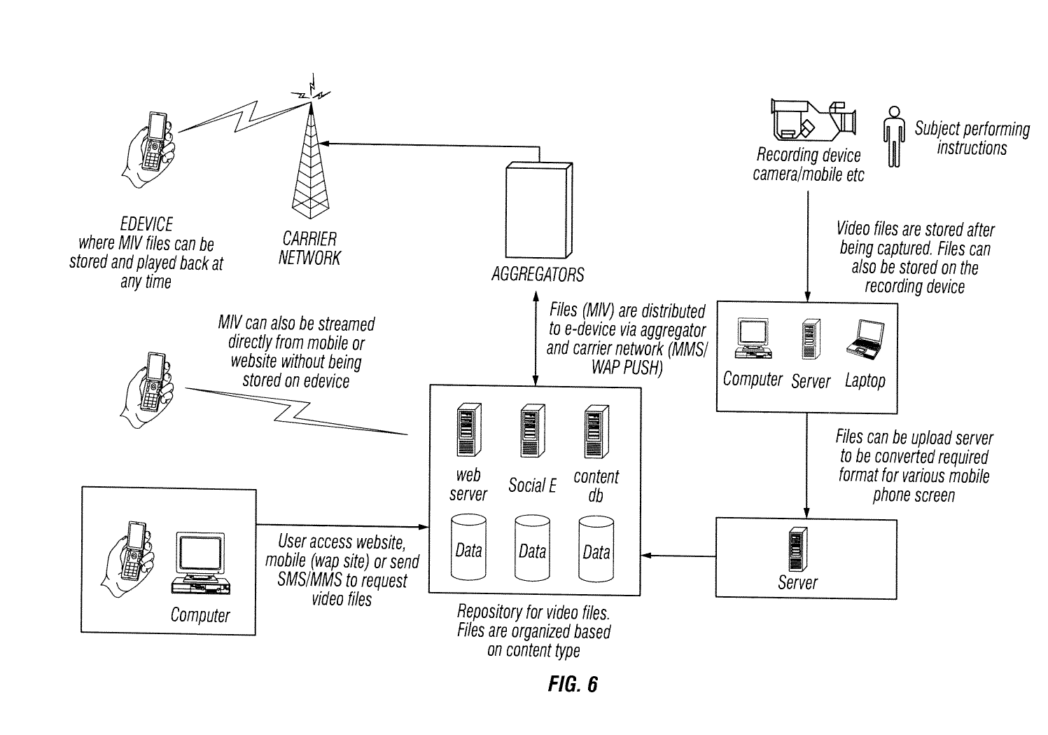

FIG. 5 presents another exemplary embodiment according to the present invention whereby the structure of a server and its interface with a network is depicted. FIG. 6 further depicts an exemplary system showing the relationships of the various components and how they interact.

In one exemplary embodiment, a user may access instructional videos (with or without accompanying audio) such as for assembling a piece of furniture, like a bookshelf. The manufacturer of the item to be assembled provides a set of video instructions for guiding a user in assembly, along with accompanying audio instructions that the user may periodically or continually refer to during assembly.

In another embodiment, the video comprises an instructional manual, such as an automobile repair instruction manual, with or without accompanying audio. The user can electronically choose the specific section of the manual, such as the section describing routine maintenance on the car like changing the oil or rotating the tires. In operation, the user uses the instructional video as a guide in performing the relevant activity, and may repeatedly rewind the video to ensure he/she closely follows the instructions as presented on the video.

In still another embodiment, the invention comprises a system and method for delivering video and/or audio instructions to a user on an expedited basis. For example, emergency medical first aid procedures are often critical to users who call 9-1-1 for emergency assistance. A user calls or accesses an emergency dispatcher via a 9-1-1 phone call, or an emergency text message, or via an Internet Website. Where the user uses a cellular phone, for example, the 9-1-1 operator often provides verbal instructions to the caller, such as how to perform the Heimlich maneuver on a choking individual, or to apply pressure to a profusely bleeding wound. The stress of the situation can cause the caller to ask the operator to repeat instructions, where the potential loss of life or other permanent harm is risked by any delays of the user to act. In this embodiment, the caller requests instructions for assisting an injured individual, and the operator can immediately transmit a video demonstrating the proper technique required. Another example is where a person is having a heart attack or seizure and the caller is attempting to assist the victim of the heart attack or seizure. Again, the operator can transmit the appropriate instructions that have been pre-recorded for such distribution to emergency callers, and the instructional video advantageously leads the caller through the proper steps to help the victim until professional help arrives. The visual guide permits the caller to perform the action without necessarily requiring simultaneous guidance, and this helps ensure the action can be performed even where the surrounding environment is quite noisy and audio-only instructions might not be effective. A further example is where an individual suffers a burn injury, such as a common first-, second- or third-degree burn. The user or another person contacts 9-1-1 via a cellular phone or other e-device and requests assistance for treating the burn injury. Since a burn injury typically requires quick intervention to avoid further tissue damage, it is critical to provide first aid to the victim as quickly as possible. Also, any burn injury presents a risk of infection, thus the victim requires immediate assistance in minimizing any further damage to the outer skin. The 9-1-1 operator electronically selects the appropriate video from the relevant electronic database, and transmits the video showing the nature of burn types and appropriate first aid intervention to the caller, so that the victim (or assisting individual) can immediately begin applying the specified treatment. Further, the instructional first aid video provides clear guidance keeping the burn wound as clean as possible until the victim visits a medical professional. Still a further example is a survival skills video, whereby the video provides succinct yet complete instructions/guidance to a user who is stranded in a wilderness, desert, or other harsh environment, particularly during inclement weather conditions. Other survival skills videos within the scope of the invention provide video instructions to a user confronting a tornado, hurricane, earthquake, flood, or other natural disaster.

Another example of a system and method for delivering video and/or audio instructions to a user on an expedited basis applies where a user contacts an emergency auto service for towing or repair. In this case, where the user who has suffered an engine failure, deflated tire, broken transmission, or other situation requiring assistance from a towing service, the user contacts the emergency automobile service provider such as the Automobile Association via cellular telephone or other e-device, including via a text message or instant messaging feature. As the user describes common engine problems or other problems to the provider, then the emergency provider transmits the instructional video with or without accompanying audio for the caller to potentially fix the problem without the need for a service technician to physically travel to the caller's location. Also, the provider has access to customized instructions for specific vehicle types and/or specific manufacturer vehicles, thus providing very focused instructions to the caller without sacrificing the speed of providing effective assistance to the user. Moreover, the caller can repeatedly replay, pause, fast-forward, or rewind the received instructions, thus providing the user with a means for resolving the problem on his/her own.

In yet another embodiment, there is provided a health and nutrition video module where the video includes, for example, one or more professional chefs demonstrating menu preparation. The video also includes close-up images of specific techniques, such as methods of de-boning meat, examples of proper mixing techniques, and the like. The video also provides guidance in selecting healthy ingredients, as well as information on calorie content for particular foods. While all types of cooking and nutrition are available in the videos, the users with restricted diets further benefit from focused instructions. For example, a special series of videos are available for diabetics, vegans, low-calorie diets, low-sodium diets, low-fat diets, and the like. The videos are also available based on cuisine types and styles, such as all-Italian foods, all-Chinese foods, all-barbecue foods, and so forth. Further videos are provided for viewing during grocery shopping, so that the user can have an entire menu efficiently presented for a concise shopping trip.

In another embodiment according to the invention, there is provided a foreign language or sign language teaching video for use with the principles of the invention. For example, a foreign language having unique non-Roman letter characters, such as the Chinese, Japanese, Korean, or Arabic languages, can be displayed on the video screen of the e-device while the user is instructed as to the grammatical and spelling rules associated with the language via the audio portion of the video playing on the e-device. Moreover, since learning sign language typically requires visual instruction as to hand and finger positions to form the specific letters and words, the video presentation along with the simultaneous audio instruction facilitates efficient learning of the language(s). The portability aspect of the e-device is especially advantageous where the user requires the assistance of the language training video during a visit to a foreign country, or even where the use of sign language would facilitate communication with a deaf individual.

In still another embodiment, there is provided a self-defense video or set of videos, whereby the user is presented with various martial-arts and related defense moves, in order to fend off an attacker, or to otherwise provide for the user's self-defense. Moreover, where the specific martial arts training requires proficiency of certain defense moves, the portability of the e-device helps the user to practice such moves at a location where a training instructor might not be available, or where the user desires to practice such moves in a limited size area, such as bedroom or hotel room during travel.

In another embodiment, there is provided a user-defined video résumé. The video résumé comprises a video where the user self-records his professional accomplishments, training, education, interests, etc., and optionally describes publications and professional or personal affiliations and memberships. The user may also provide any other pertinent information to the potential employer via the video résumé, along with audio describing all relevant activities. The user chooses from a server-generated list of employers who accept such video résumés, and the user electronically responds by submitting his video résumé via his e-device. The receiving entity can then review the video multiple times, as well as share the video with potentially interested hiring personnel. This approach to candidate screening is especially advantageous where an applicant is unable to travel to the entity's physical location, or even where the potential employer pre-screens applicants via the video résumé before authorizing the applicant to travel to the entity's location at the expense of the hiring entity. Video résumés are also advantageous for internal reassignments of applicants, whereby the current employer can circulate the individual's video résumé to other department managers for review, without requiring the applicants to spend physical time away from their current work assignments. This approach is further advantageous where internal or external applicants could provide video résumés to multiple hiring managers simultaneously, and the receiving entity would not be obligated to respond to the applicant unless the applicant's credentials merit further review by the hiring entity. Moreover, where the hiring entity does not extend an invitation for any further interview possibilities with the employer, then the entity can electronically store the video résumé for future job opportunities that may better fit the applicant, without requiring the applicant to reapply for the specific job opportunity.

In yet another embodiment, the various videos described herein include an advertising block on the video, so that the originator of the video may post its logo or other information in a conspicuous yet unobtrusive portion of the video without compromising the integrity of the video image. One example is a fitness instructional video where a health club or fitness equipment manufacturer or supplier includes its logo in the lower corner of the video. The advertising logo can be incorporated before the video playback as an introductory screen, during the video, or even after the video playback to further reinforce the information with the user who views the video.

Moreover, the advertising block alternatively comprises an active link to the advertiser's or supplier's Website or other electronic destination, such as an order page, a list of other available electronic videos, and the like. The advertising block or logo may also consist of one or more different entities, such as by electronically rotating the content within the block. One example would be a specific advertiser's logo that is displayed at the beginning of the video playback, another entity's logo plays during the video, and still another entity's logo is displayed toward the end of the video. The speed with which the entity logos appear or are cycled through the video may be adjusted to numerous settings. Where the video comprises a user-defined video resume, the advertising block can be an electronic link to the user's email address, or other contact information for the user. The block can also be an electronic link to automatically place a call to the user (where the user has encoded the calling information/number), further providing an efficient means for contacting the user. Moreover, assigned codes may be designated for one or more specific videos or video categories, thereby providing users with a single point for accessing groups of videos without requiring multiple queries to be sent to the server.

The above-described videos and other various video subjects are available to a user in the same manner as herein described, and the invention is in no way intended to be limited to only these exemplary embodiments.

Demonstration videos are preferentially produced in a room with an adequate amount of space, so that the activities can be performed along with, e.g., exercise equipment, demonstration equipment, various cameras and other recording devices, a camera crew, video and other related audio equipment. During the video production process, the camera person preferentially films only the body part of the person performing the exercise or other designated activity in regards to the particular body part that is being addressed, therefore having the highest quality and focused image of only the body part on one's e-device (such as a wireless handset), although some activities may require the whole body shown on the video. Moreover, the video production also includes split-screen images, where a specific section of a body or device is highlighted on one screen form a close-up angle, and the other portion(s) of the divided screen show a broader view of the activity. The video clips are edited and compressed into, but not limited to, 3G, 3G2, 3GP, 3GGP, 3GPP, 3GPP2, AVI, MP4 and WMV formats. The video playback length may vary from several seconds to one minute or more, depending on the complexity of the activity presented in the video, with a preferred video length of 15 to 45 seconds. Further, the videos may be presented as a single program, or may be portioned into segmented portions for more efficient viewing.

The term “video” as used herein refers to motion, as distinguished from still (i.e., static), picture images. This term further includes animated motion pictures, while also including electronic film images of real-life images. The term also encompasses streaming videos, whereby the initiation of a video transmission results in immediate playback on the receiving e-device without waiting for the complete video file to be transmitted and received on the e-device. Also, burst videos are included in the term, where electronic data packets of information are transmitted intermittently to the e-device, so that the electronic file is broken into discrete units that are transmitted in a series of smaller, individual parts. Further, the term includes electronic motion images maintained as a single electronic file that is transmitted as a single, complete unit to the e-device.

While certain embodiments of the invention are described above, it should be understood that the invention can be embodied and configured in many different ways without departing from the spirit and scope of the invention. For example, while specialized software is not necessarily required the use of the invention in connection with various e-devices, such specialized or proprietary software may be used in connection with the invention without compromising its effectiveness. Accordingly, some e-device providers may include software that enhances the delivery, storage, and/or playback functionality of the particular e-device. Also, the e-device may be further customized for maximum connectivity transmission speed, as well as enhanced audio features for sound quality. These optional customizable aspects of the e-device do not detract from the operation of the invention as herein described.

Further, while the invention has been described in detail with reference to exemplary embodiments thereof, it will be apparent to one skilled in the art that various changes can be made, and equivalents employed, without departing from the scope of the invention. Each of the aforementioned documents is incorporated by reference herein in its entirety.

What is claimed is:

1. A delivery method for providing a training video for a personal mobile trainer comprising:
a. receiving by a centralized provider an electronic query initiated by an e-device;
b. sending by the centralized provider an opt-in message to the e-device in response to the query;
c. receiving by the centralized provider an affirmative reply to the opt-in message from the e-device; and
d. sending by the centralized provider a selected video transmission of one or more videos to the e-device in response to the affirmative reply to the opt-in message from the e-device.

2. A delivery method according to claim 1 wherein the electronic query is selected from the group comprising a user-specified text message, a pre-formatted query list, an e-mail, and a voice input.

3. A delivery method according to claim 1 wherein the e-device is selected from the group comprising a cellular phone, a PDA, a micro PC, a laptop computer, a desktop computer, a networked laptop or desktop computer, a video player, an MP3 player, and a television.

4. A delivery method according to claim 1 wherein the centralized provider is selected from an affiliated server, a dedicated server, an associated server, and an open-access server.

5. A delivery method according to claim 1 wherein the opt-in message further comprises a disclaimer or a broadcast message.

6. A delivery method according to claim 1 wherein the acceptance of the opt-in message is selected from an electronic indication via text message, an e-mail, an electronic acceptance via a Website, a response to an Internet-based system, or a response by checking a yes box or its graphic equivalent.

7. A delivery method according to claim 1 wherein the one or more selected video transmissions is streamed from the centralized provider to the c-device in response to a single the acceptance of a block of videos requested, and wherein the one or more selected videos optionally contains audio therewith.

8. A delivery method according to claim 1 wherein the one or more videos is selected from a streaming video file, a burst video file, and a single electronic file.

9. A delivery method according to claim 1 wherein the video is selected from:
a cooking instructional video; a fitness training video; an exercise demonstration video; a furniture assembly instructional video; an automobile repair instructional video; an emergency medical first aid video; an automobile emergency instructional video; a personal health and nutrition instructional video; a self-defense training video; a foreign language or sign language training video; a dancing instruction video; a video resume; and a survival skills video.

10. A personal mobile trainer system comprising:
a. means for receiving by a centralized provider an electronic query initiated by an e-device;
b. means for sending by the centralized provider an opt-in message to the e-device in response to the query;
c. means for receiving by the centralized provider an affirmative reply to the opt-in message from the c-device;
d. means for sending by the centralized provider a selected video transmission of one or more videos to the e-device in response to the affirmative reply to the opt-in message from the e-device;
e. wherein the user-selected video comprises an instructional video; and
f. wherein the e-device further comprises a means for playing and/or electronically storing the user-selected video distributed from the centralized provider.

11. A personal mobile trainer system according to claim 10 wherein the electronic query is selected from a user-specified text message, a pre-formatted query list, an e-mail, and a voice input.

12. A personal mobile trainer system according to claim 10 wherein the e-device is selected from a cellular phone, a PDA, a micro PC, a laptop computer, a desktop computer, a networked laptop or desktop computer, a video player, an MP3 player, and a television.

13. A personal mobile trainer system according to claim 10 wherein the centralized provider is selected from an affiliated server, a dedicated server, an associated server, and an open-access server.

14. A personal mobile trainer system according to claim 10 wherein the opt-in message further comprises a disclaimer or a broadcast message.

15. A personal mobile trainer system according to claim 10 wherein the acceptance of the opt-in message is selected from an electronic indication via text message, an e-mail, an electronic acceptance via a Website, a response to an Internet-based system, or a response by checking a yes box or its graphic equivalent.

16. A personal mobile trainer system according to claim 10 wherein the one or more selected video transmissions is streamed from the centralized provider to the e-device in response to a single the acceptance of a block of videos requested, and wherein the one or more selected videos optionally contains audio therewith.

17. A personal mobile trainer system according to claim 10 wherein the one or more videos is selected from a streaming video file, a burst video file, and a single electronic file.

18. A personal mobile trainer system according to claim 10 wherein the video is selected from the group comprising:
a cooking instructional video; a fitness training video; an exercise demonstration video; a furniture assembly instructional video; an automobile repair instructional video; an emergency medical first aid video; an automobile emergency instructional video; a personal health and nutrition instructional video; a self-defense training video; a foreign language or sign language training video; a dancing instruction video; a video resume; and a survival skills video.
